(19) United States
(12) Patent Application Publication
(10) Pub. No.: US 2026/0310392 A1
(43) Pub. Date: Oct. 8, 2026

(54) PRINT MANAGEMENT SYSTEM, IMAGE FORMING APPARATUS, MANAGEMENT SERVER, STORAGE MEDIUM, AND PRINT MANAGEMENT METHOD

(71) Applicant: CANON KABUSHIKI KAISHA, Tokyo (JP)

(72) Inventor: TERUHIKO SUZUKI, Kanagawa (JP)

(21) Appl. No.: 19/637,894

(22) Filed: Apr. 2, 2026

(30) Foreign Application Priority Data
Apr. 7, 2025 (JP) 2025-063356

(51) Int. Cl. G06F 3/12

(52) U.S. Cl. CPC G06F 3/1239; G06F 3/1203; G06F 3/1226; G06F 3/1287; G06F 3/1288

(57) ABSTRACT

A print management system includes a plurality of image forming apparatuses and a management server. Each of the plurality of image forming apparatuses holds a printable number of sheets corresponding to a total number of sheets that can be printed. A first image forming apparatus among the plurality of image forming apparatuses obtains, in a case where a first printable number of sheets held by the first image forming apparatus is insufficient with respect to a number of sheets corresponding to a received printing instruction, via the management server, a printable number of sheets corresponding to the number of sheets that are insufficient from a second image forming apparatus among the plurality of image forming apparatuses holding a second printable number of sheets equal to or greater than the number of sheets that are insufficient.

### BACKGROUND

### Field of the Technology

The technology of the present disclosure relates to optimization of the number of print sheets purchased in a prepaid printing service in which the number of print sheets is purchased beforehand, for example, and in particular relates to a print management system, an image forming apparatus, a management server, a storage medium, and a print management method for this.

### Description of the Related Art

A prepaid printing service is known in which a printable number of sheets (hereinafter referred to as charged number of sheets) is purchased in advance (hereinafter referred to as charging) for each image forming apparatus, and printing can be performed up to the charged number of sheets. Japanese Patent Laid-Open No. 2021-68372 discloses technology relating to such a prepaid printing service in which a user can perform printing upon purchasing one of a plurality of options indicating “combinations of a charged number of sheets and a charge amount” displayed by a program running on a user device.

Recently, due to telework becoming more common, there are an increasing number of cases where freelancers, office-less startup companies, SOHO groups, and the like perform commercial printing using an image forming apparatus personally owned or provided by an affiliated organization. It is also not uncommon for an image forming apparatus that supports a prepaid printing service according to the known technology described above to be used for commercial printing. However, with the technology disclosed in Japanese Patent Laid-Open No. 2021-68372, it is compulsory that the user of the image forming apparatus selects one of the charged number of sheets options set in advance. If the user as an individual is made to perform the charge, there is a high possibility that the charge is excessive. Thus, cost management is an important issue with commercial printing.

### SUMMARY

With the technology of present disclosure, cost management relating to printing can be appropriately and flexibly performed by enabling the borrowing of printable number of sheets between printers within a printer group.

One aspect of the present disclosure provides a print management system comprising: a plurality of image forming apparatuses; and a management server, wherein each of the plurality of image forming apparatuses holds a printable number of sheets corresponding to a total number of sheets that can be printed, and a first image forming apparatus among the plurality of image forming apparatuses includes: at least first memory storing instructions; and at least first processor that is in communication with the at least first memory and that, when executing the instructions, cooperates with the at least first memory to execute processing, the processing including: in a case where a first printable number of sheets held by the first image forming apparatus is insufficient with respect to a number of sheets corresponding to a received printing instruction, obtaining, via the management server, a printable number of sheets corresponding to the number of sheets that are insufficient from a second image forming apparatus among the plurality of image forming apparatuses holding a second printable number of sheets equal to or greater than the number of sheets that are insufficient.

According to the configurations described above, cost management relating to printing can be appropriately and flexibly performed by enabling the borrowing of printable number of sheets between printers within a printer group.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a configuration diagram of an information processing system.

FIG. 2 is a block diagram illustrating the hardware configuration of a server.

FIG. 3 is a block diagram illustrating the hardware configuration of an image forming apparatus.

FIG. 4 is a block diagram illustrating the hardware configuration of a user terminal.

FIG. 5A is a screen flow diagram of when generating or joining of a printer group is executed.

FIG. 5Ba is a diagram illustrating an example of a printer group screen displayed on the user terminal.

FIG. 5Bb is a diagram illustrating an example of a printer group creation screen displayed on the user terminal.

FIG. 5Bc is a diagram illustrating an example of a printer group creation complete screen displayed on the user terminal.

FIG. 5Bd is a diagram illustrating an example of a printer group joining screen displayed on the user terminal.

FIG. 5Be is a diagram illustrating an example of a printer group joining complete screen displayed on the user terminal.

FIG. 6 is a sequence diagram of printer group creation.

FIG. 7 is a sequence diagram of printer group joining.

FIG. 8A is a sequence diagram of charge gift request transmission.

FIG. 8Ba is a diagram of an example of a print screen displayed on the user terminal.

FIG. 8Bb is a flow diagram of insufficient charge number calculation.

FIG. 9A is a sequence diagram of charge gift processing.

FIG. 9Ba is a diagram illustrating an example of a charge gift request permission screen.

FIG. 9Bb is a diagram illustrating an example of a charge gift transmission notification screen.

FIG. 9Bc is a diagram illustrating an example of a charge gift reception notification screen.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

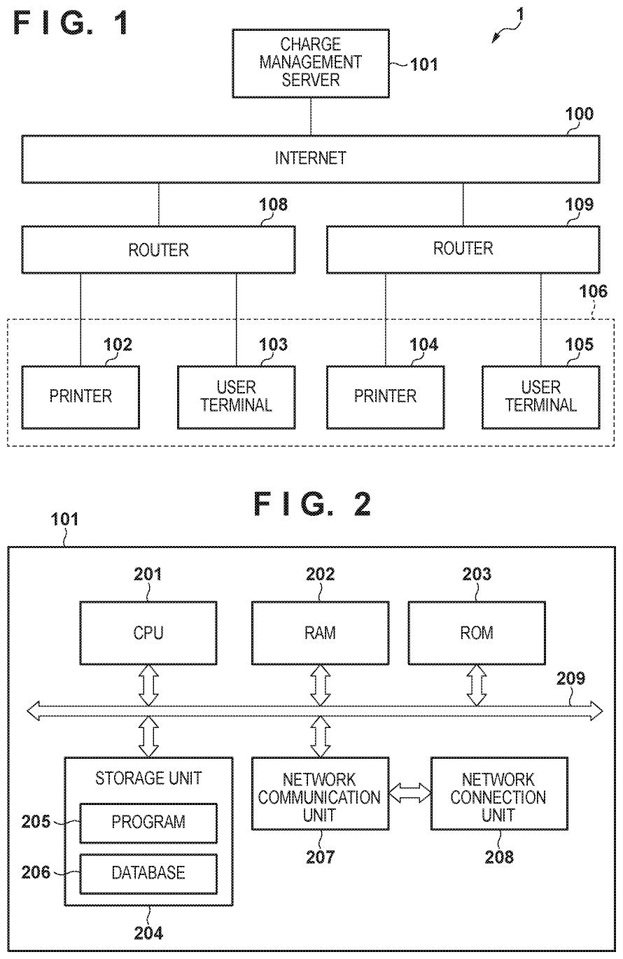

FIG. 1 is a diagram illustrating the overall configuration of an information processing system or a print management system according to the present embodiment. As illustrated in FIG. 1, an information processing system 1 according to the present embodiment includes a charge management server 101, a printer 102 and a printer 104 which are image forming apparatuses to which a prepaid printing service is applied, and a user terminal 103 and a user terminal 105 which are information processing apparatuses. Also, the printer 102 and the printer 104 form a printer group 106. The charge management server may also be simply referred to as a management server. The printers 102 and 104 can communicate with the user terminals 103 and 105 via routers 108 and 109, respectively. Also, the printer 102, the printer 104, the user terminal 103, and the user terminal 105 are each connected to the Internet 100 via the router 108 or 109 and can communicate with the charge management server 101. Note that in this example, only the printer 102 and the printer 104 are members of the printer group 106. However, the number of printers that are members is not particularly limited. The printer 102 and the user terminal 103 and the printer 104 and the user terminal 105 may each be connected to the same network, and each network may be connected to the Internet 100 via a router.

Also, in the present embodiment, the printer 102 is ready to use the prepaid printing service via the user terminal 103, and the printer 104 is ready to use the prepaid printing service via the user terminal 105. In other words, the printers 102 and 104 have already stored the information associating the printer ID and the like and the remaining charge amount of the printer illustrated in Table 1. The remaining charge amount is a value corresponding to the number of sheets that can be printed (printable number of sheets) assigned in accordance with the payment by the user, for example, and is totaled via a predetermined process. In the present embodiment, the remaining charge amount can be traded regardless of whether it is at a cost or no cost. The process up until when the printers are ready to use the prepaid printing service will not be described in detail. Also, the information stored for the printers 102 and 104 to use the prepaid printing service is not limited to the information illustrated in Table 1. The remaining charge amount may also be referred to as the charge amount, the charge number, or the printable number of sheets.

TABLE 1
Example of Printer Information stored by Printer 102 (104)

| Device ID | Remaining Charge Amount |
|---|---|
| PrinterA | 50 |

Table 1 indicates that the remaining charge amount of the printer with the device ID (identification information) of PrinterA is 50, and that printing of a predetermined number of sheets (in the present example, 1) per unit quantity can be performed. Note that if the printer holds its device ID separately, it is sufficient that only the remaining charge amount is held as printer information as it can be associated with the device ID. In a case where the printer 102 receives a printing instruction from the user terminal 103 and executes printing in accordance with the printing instruction, the number of sheets in accordance with the printing instruction is subtracted from the remaining charge amount. When the remaining charge amount reaches 0, printing can no longer be performed. If the remaining charge amount is greater than 0, the number of sheets in accordance with the remaining charge amount can be printed.

Note that in the following description of the embodiments, the notation “printer 102 (104)” is used to mean “the printer 102 or the printer 104”. The notation “user terminal 103 (105)” has a similar meaning.

### Configuration of Charge Management Server 101

FIG. 2 is a diagram illustrating an example of the hardware configuration of the charge management server 101. The charge management server 101 includes a CPU 201, a RAM 202, a ROM 203, a storage unit 204, a network communication unit 207, and a network connection unit 208.

The CPU 201 is a central processing unit for executing programs loaded into the RAM 202 and programs stored in the ROM 203 and controlling each unit of the charge management server 101. The RAM 202 performs the role of the working memory required when a program 205 is executed by the CPU 201. The ROM 203 is read-only memory for storing a boot program required for system activation. The storage unit 204 is an apparatus for storing the program 205 executed by the CPU 201, a database 206, and various types of information and is a non-volatile storage apparatus such as a magnetic disk or a flash memory, for example. The network communication unit 207 is connected to a network such as the Internet 100 via the network connection unit 208 and performs various types of communication. The units described above are connected to one another via a bus 209 allowing data to be transmitted and received between one another. Note that in the example illustrated in FIG. 2, the charge management server 101 is a single server (information processing apparatus) configuration, but it may be configured as a plurality of servers. In other words, each function may be executed via the cooperation of a plurality of servers.

### Hardware Configuration of Printer 102 (104)

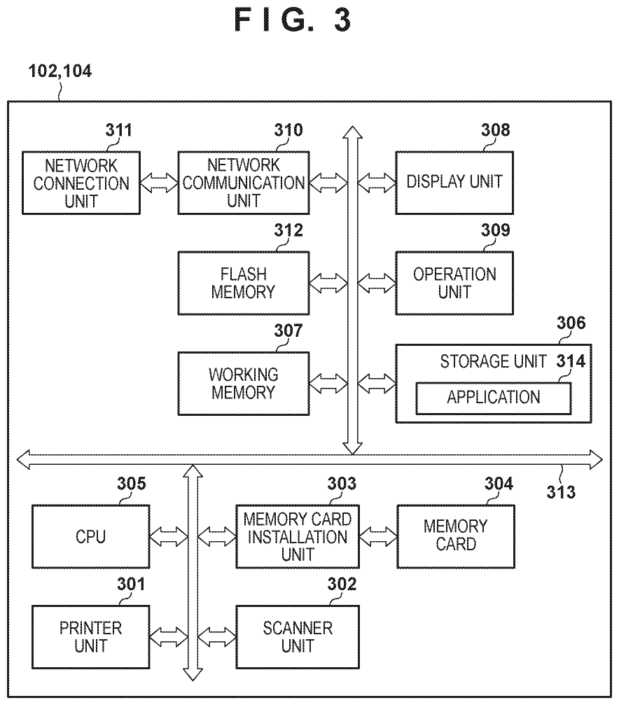

FIG. 3 is a diagram illustrating an example of the hardware configuration of the printer 102 (104), which is an image forming apparatus. In the present description, the example given of the printer 102 (104) is a multi-function peripheral with both a scanner function and a communication function. However, the present embodiment is not limited to a multi-function peripheral.

The printer 102 (104) includes a printer unit 301, a scanner unit 302, a memory card installation unit 303, a memory card 304, a CPU 305, a storage unit 306, a working memory 307, a display unit 308, an operation unit 309, a network communication unit 310, a network connection unit 311, and a flash memory 312.

In the printer 102 (104), the print function is implemented by the printer unit 301. Also, the scanner function is implemented by the scanner unit 302, and the storage function is implemented by the memory card installation unit 303 and the memory card 304. The printer unit 301 records (prints) an image on a print medium such as a sheet for printing via the inkjet method based on image data received from an external source, image data stored in the memory card 304, and the like. Also, the printer unit 301 manages remaining ink amount information and sheet information including the number of loaded sheets information. Note that “sheet” is a typical term for printing paper. The scanner unit 302 optically scans a document set on the platen (not illustrated) and converts it into electronic data and further transfers the image data converted into a designated file format to an external apparatus via a network, stores the image data in a storage area (not illustrated) such as an HDD, and the like. Also, the copy function is implemented by transferring image data generated by a document placed on a platen being scanned by the scanner unit 302 to the printer unit 301, and the printer unit 301 printing an image on a print medium based on the image data. The memory card 304 installed in the memory card installation unit 303 stores various types of file data. The file data can be read out from an external apparatus via a network and edited. Also, the file data can be stored in the memory card 304 in response to an instruction from an external apparatus.

The CPU 305 is a central processing unit for controlling each unit in the printer 102 (104). The CPU 305 executes programs loaded in the RAM included in the storage unit 306, the working memory 307, or the like and programs stored in the ROM to execute the programmed function. The storage unit 306 is constituted by a ROM or the like and stores an application 314 for communicating with the user terminal 103 (105) and the charge management server 101. Also, the application 314 is executed by the CPU 305 to access the printer unit 301 and obtain consumable information for the ink, sheets, and the like. The working memory 307 is constituted by a RAM or the like. The working memory 307 temporarily stores image data and the like at the time that each service is executed, and buffering is performed using the working memory 307.

The display unit 308 is constituted by a liquid crystal display (LCD), for example, where various types of information are displayed. The operation unit 309 is constituted by a switch or the like for the user to perform various types of input operations. Alternatively, the operation unit 309 may be a touch panel or the like integrally formed with the display unit 308. The network communication unit 310 connects to the router 108 via the network connection unit 311. In other words, the network communication unit 310 connects to a network such as the Internet 100 via the network connection unit 311 and performs various types of communication. In the various types of communication, control via HTTP, MQTT, or the like is performed. Note that the protocol used in the communication is not limited to these examples. The flash memory 312 is a non-volatile memory for storing image data received by the network communication unit 310, data (charged number of sheets and error history, printer 102 (104) system information, contract information, and the like) relating to the prepaid printing service, and the like. The units described above are connected to one another via a bus 313 allowing data to be transmitted and received between one another.

### Hardware Configuration of User Terminal 103 (105)

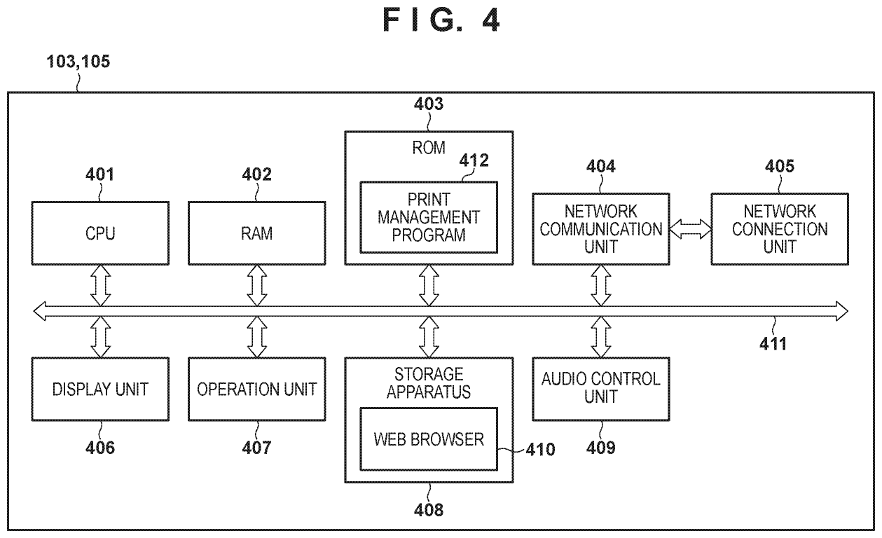

FIG. 4 is a diagram illustrating an example of the hardware configuration of the user terminal 103 (105). The user terminal 103 (105) may be a mobile terminal such as a smartphone, a personal computer, or the like, for example.

The user terminal 103 (105) includes a CPU 401, a RAM 402, a ROM 403, a network communication unit 404, a network connection unit 405, a display unit 406, an operation unit 407, a storage apparatus 408, and an audio control unit 409.

The CPU 401 is a central processing unit for executing programs loaded into the RAM 402 and programs stored in the ROM 403 and controlling each unit of the user terminal 103 (105). The RAM 402 is a working memory required when a program is executed by the CPU 401. The ROM 403 stores an operating system, a print management program 412, and the like. The print management program 412 is read out and executed by the CPU 401. The print management program 412 has the functions of receiving operations from the user, transmitting input data, image files, and the like to the charge management server 101 via the Internet 100, and notifying the user with a message received from the charge management server 101. Also, the print management program 412 has the function of internally opening a web page. The network communication unit 404 connects to the router 108 via the network connection unit 405. In other words, the network communication unit 404 is connected to a network such as the Internet 100 via the network connection unit 405 and performs various types of communication. The network communication unit 404 supports wireless LAN. Note that the network communication unit 404 may be directly connected to a network such as the Internet 100, bypassing the router 108.

The display unit 406 is constituted by an LCD or an organic light-emitting diode (OLED), for example, and displays various types of information. The operation unit 407 performs control of information as instructed by the user via a button or touch panel of the user terminal 103 (105). The operation unit 407 may be a touch panel or the like integrally formed with the display unit 406. The storage apparatus 408 is a non-volatile storage apparatus and stores various types of operation mode settings, operation logs, and the like required to be held even after the user terminal 103 (105) is restarted. The audio control unit 409 is mainly activated by a calling application and is used when the user makes a phone call. The input and output of audio data is performed via a microphone and speaker (not illustrated), and the audio control unit 409 functions as an intermediary between these and the control program. A web browser 410 is software for viewing a webpage (web site) via the Internet loaded in the RAM 402 and executed by the CPU 401, for example. The units described above are connected to one another via a bus 411 allowing data to be transmitted and received between one another. Note that in the present embodiment, the user terminal 103 (105) is a mobile terminal, but the user terminal 103 (105) may be an information processing apparatus such as a personal computer or tablet terminal.

### Printer Group Creation Processing

In the following description, a printer group is created using the user terminal 103, and the printer that communicates with the user terminal 103 is the printer 102.

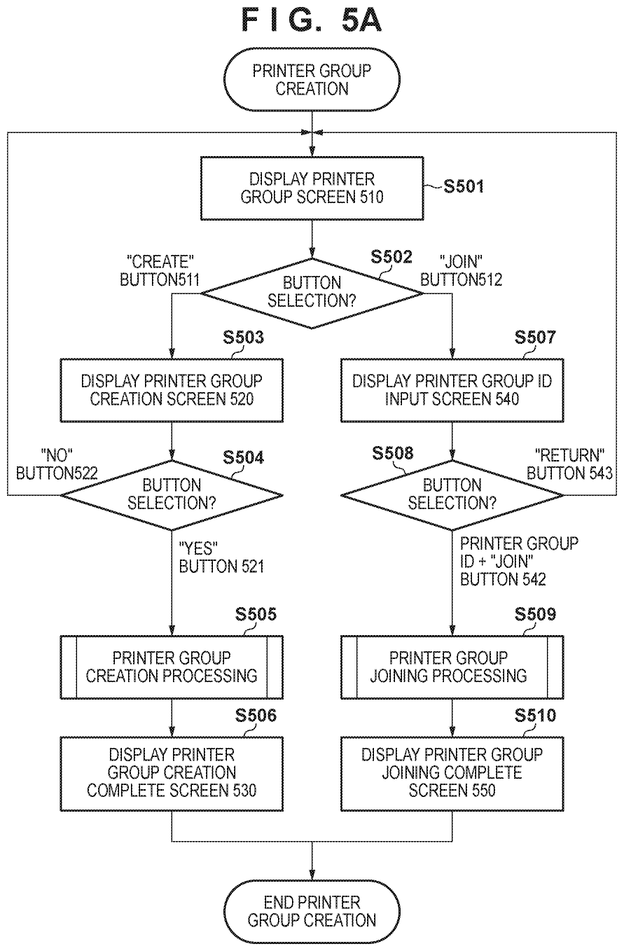

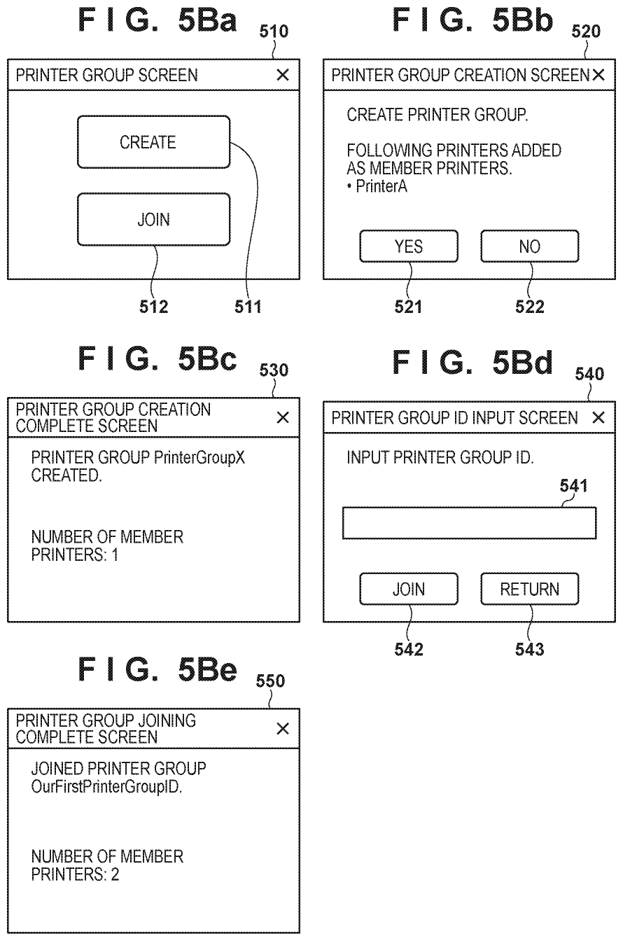

An example of the screen flow for creating a printer group from the user terminal 103 will be simply described with reference to the flow of FIG. 5A and the user interface (UI) of FIGS. 5Ba to 5Be. The screen flow is implemented by the print management program 412 being executed by the CPU 401. In other words, each process of the flowchart of FIG. 5A is executed by the CPU 401.

First, when the user runs the application program for creating a printer group from the home screen or the like, in S501, the CPU 401 displays a printer group screen 510 illustrated in FIG. 5Ba as the UI. In S502, in a case where a button on the printer group screen 510 has been touched, the CPU 401 determines which button has been selected. When a “Create” button 511 is selected on the printer group screen 510, in S503, the CPU 401 displays a printer group creation screen 520 illustrated in FIG. 5Bb. In S504, in a case where a button on the printer group creation screen 520 has been touched, the CPU 401 determines which button has been selected. When a “Yes” button 521 is selected on the printer group creation screen 520, in S505, the CPU 401 executes the printer group creation processing. When the printer group creation processing is successful, in S506, the CPU 401 displays a printer group creation complete screen 530 illustrated in FIG. 5Bc. In S504, when a “No” button 522 is selected on the printer group creation screen 520, the printer group creation processing is not started, and the CPU 401 returns the processing to S501 and displays the printer group screen 510.

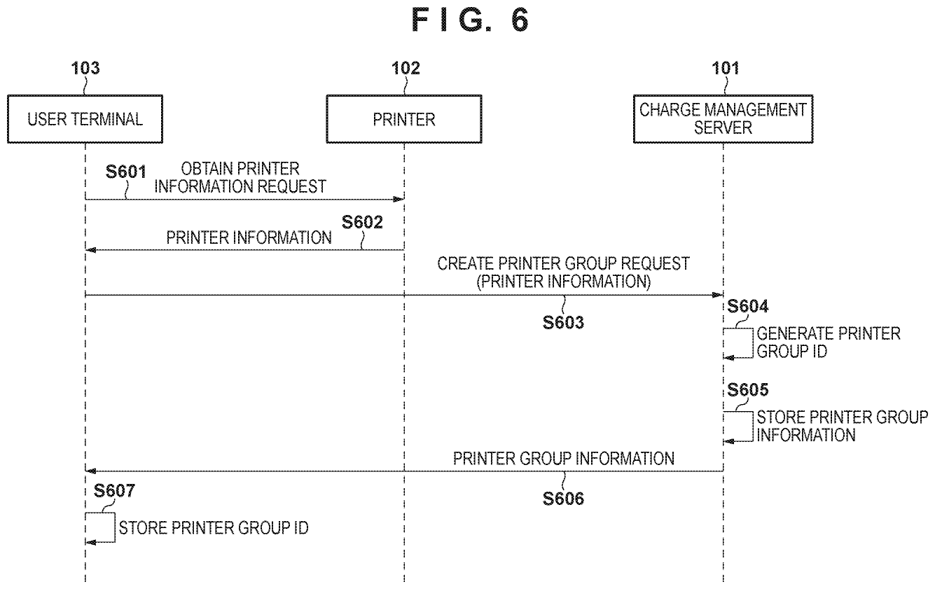

FIG. 6 is a sequence diagram representing S505 of the printer group creation processing. The processing of each apparatus appearing in FIG. 6 is implemented by the respective CPUs executing a program.

In S601, the user terminal 103 transmits an obtain printer information request to the printer 102. When the printer 102 receives the obtain printer information request, in S602, the printer 102 responds with printer information including the device ID and remaining charge amount indicated in Table 1. In S603, the user terminal 103 transmits the printer information received in S602 to the charge management server 101 together with a create printer group request. When the charge management server 101 receives the create printer group request, in S604, the charge management server 101 creates a printer group ID for uniquely identifying the printer group, and in S605, the charge management server 101 stores the printer group information in the format indicated in Table 2.

TABLE 2
Example of Printer Group Information stored
by Charge Management Server 101

| Printer Group ID | Device ID | Remaining Charge Amount |
|---|---|---|
| PrinterGroupX | PrinterA | 50 |

In the printer group information, the printer group ID, the device ID of the printer belonging to the printer group, and the remaining charge amount are associated together. Since Table 2 is an example at the time of creation, PrinterGroupX only includes PrinterA, and the remaining charge amount corresponds to the remaining charge amount for the PrinterGroupX. In a case where a printer is added to the printer group and PrinterGroupX includes a plurality of printers, the device ID of each printer and the respective remaining charge amounts are associated with the printer group ID and managed. Note that the remaining charge amount of each printer is spent by the printer and thus does not necessarily match that of the printer group information held by the charge management server 101. Thus, the remaining charge amount does not need to be included in the printer group information.

When S605 ends, in S606, the charge management server 101 responds to the user terminal 103 with the printer group information including the printer group ID. When the user terminal 103 receives the printer group information, in S607, the printer group information where the device ID and the printer group ID that the printer belongs to are associated together are stored in the format indicated in Table 3.

TABLE 3
Example of Printer Group Information
stored by User Terminal 103

| Device ID | Printer Group ID |
|---|---|
| PrinterA | PrinterGroupX |

As indicated in Table 3, though the remaining charge amount is included in the printer group information held by the charge management server 101, the remaining charge amount is not included in the printer group information held by the user terminal 103.

### Printer Group Joining Processing

In the following description, the printer joining the printer group is the printer 104, and the user terminal communicating with the printer 104 is the user terminal 105.

An example of the screen flow for joining the printer group from the user terminal 103 will be described using FIG. 5A. In S502 of FIG. 5A, in a case where a “Join” button 505 is selected on the printer group screen 510, in S507, the CPU 401 displays a printer group ID input screen 540 illustrated in FIG. 5Bd. When a printer group ID 541 is input and a “Join” button 542 is selected on the printer group ID input screen 540, in S509, the CPU 401 executes the printer group joining processing. When the printer group joining processing is successful, in S510, the CPU 401 displays a printer group joining complete screen 550 illustrated in FIG. 5Be. On the other hand, in S508, in a case where a “Return” button 602 is selected, the CPU 401 returns the processing to S501 and displays the printer group screen 510.

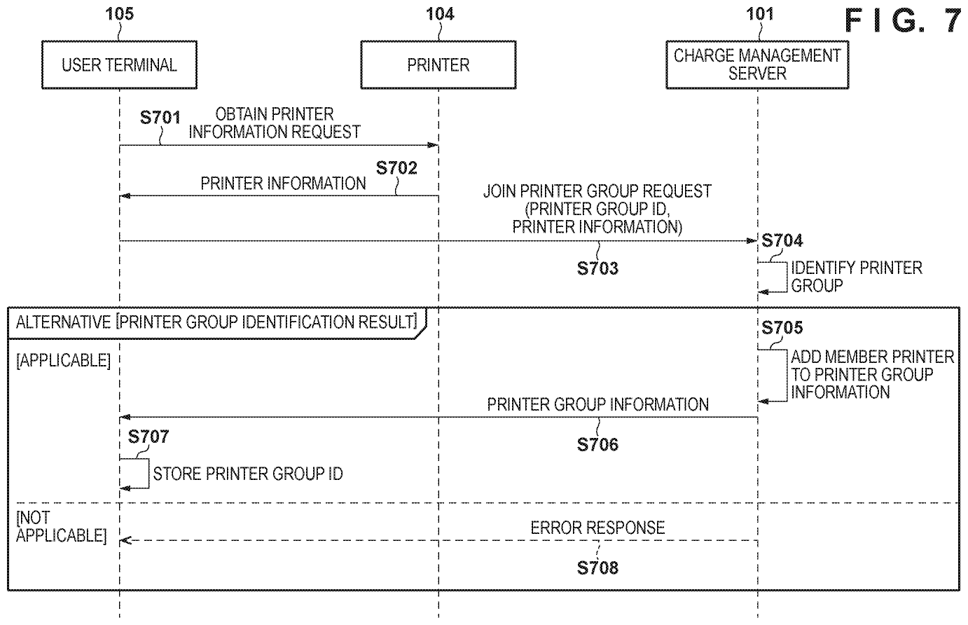

FIG. 7 is a sequence diagram representing the printer group joining processing. The processing of each apparatus appearing in FIG. 7 is implemented by the respective CPUs executing a program.

In S701, the user terminal 105 transmits an obtain printer information request to the printer 104. When the printer 104 receives an obtain printer information request, in S702, the printer 104 responds with printer information including the device ID and remaining charge amount stored in the printer group information table of Table 1. In S703, the user terminal 105 transmits the printer information received from the printer 104 and the printer group ID input into an input portion 541 of the printer group ID input screen 540 to the charge management server 101 together with a join printer group request. When the charge management server 101 receives the join printer group request, in S704, the charge management server 101 identifies the printer group via the received printer group ID. In a case where the printer group can be identified, in S705, the charge management server 101 updates the printer group information to the format indicated in Table 4. In other words, printer group information in which the printer ID and the remaining charge amount received in S703 are added to the printer group with the printer group ID received in S703 is created.

On the other hand, in S704, in a case where the printer group cannot be identified via the printer group ID received in S703, in S708, an error communicating that the printer group cannot be identified is sent as a response to the user terminal 105.

TABLE 4
Example of Printer Group Information updated
by Charge Management Server 101

| Printer Group ID | Device ID | Remaining Charge Amount |
|---|---|---|
| PrinterGroupX | PrinterA | 50 |
| PrinterGroupX | PrinterB | 100 |
| PrinterGroupY | PrinterC | 200 |
| PrinterGroupX | PrinterD | 50 |
| PrinterGroupZ | PrinterE | 600 |

In the example of Table 2, only the PrinterA with a remaining charge amount of 50 belongs to the PrinterGroupX, but in the example of Table 4, PrinterB with a remaining charge amount of 100 and PrinterD with a remaining charge amount of 50 are newly added. Also, in Table 4, PrinterGroupY and PrinterGroupZ each with one associated printer are registered.

When S705 ends, in S706, the charge management server 101 transmits the printer group information including the printer group ID to the user terminal 105. When the user terminal 105 receives the printer group information, in S707, the user terminal 105 stores the printer group information in the format indicated in Table 5. Note that in a case where a printer that is the target of a join printer group request is already registered as a member of the printer group it is being entered into, the processing of S705 is not required. In this case, the charge management server 101 may respond to the user terminal 105 which is the source of the request in S706 with the printer group information corresponding to the printer group ID received in S703. Also, the user terminal 105 that received this may store the received printer group information in S707.

TABLE 5
Example of Printer Group Information
stored by User Terminal 105

| Device ID | Printer Group ID |
|---|---|
| PrinterB | PrinterGroupX |

In a similar manner to Table 3, the printer group information of Table 5 is information where the device ID and the printer group ID that the printer belongs to are associated together.

### Charge Gift Request Transmission Processing

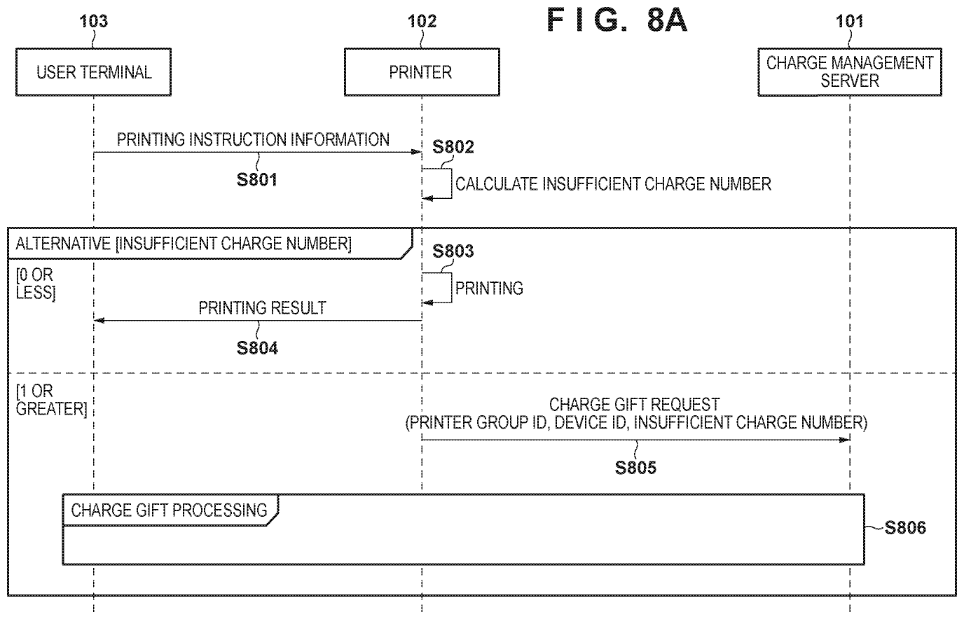

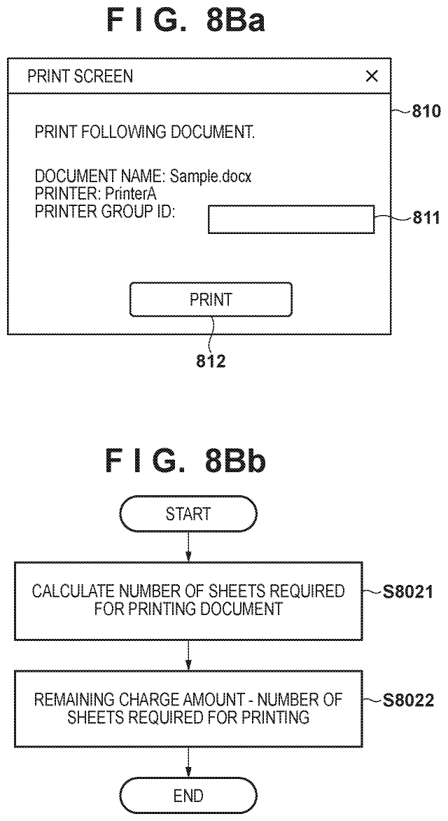

In the following description, the printer that performs printing is the printer 102, and the user terminal is the user terminal 103. FIG. 8A is a sequence diagram for the execution of printing via a charge gift. FIG. 8Ba illustrates a print screen 810 displayed on the user terminal 103. The processing of each apparatus appearing in FIG. 8A is implemented by the respective CPUs executing a program.

When an operation for selecting a document to print and the printer to use (referred to as a print destination printer) and for printing is performed by the user on the user terminal 103, the print screen 810 is displayed on the user terminal 103. When the user inputs the printer group ID in a printer group ID input portion 811 and selects a print button 812 on the print screen 810, the user terminal 103 creates printing instruction information (not illustrated) and transmits this to the printer 102 in S801. The printing instruction information includes information of the document to be printed, the device ID of the print destination printer, the input printer group ID, and the like. When the printer 102 receives the printing instruction information from the user terminal 103, in S802, insufficient charge number calculation processing is executed. Note that in the present example, the unit for the charge number corresponds to one sheet. In other words, the charge number indicates the number of sheets that can be printed.

FIG. 8Bb is a flowchart for describing the insufficient charge number calculation processing of S802. The processing of FIG. 8Bb is executed by the CPU 305 of the printer 102. In S8021, the CPU 305 of the printer 102 calculates the number of sheets (number of sheets required for printing) to be printed via the printing instruction from the printing instruction information. The number of sheets required for printing may be calculated in accordance with the number of pages of the document to be printed and the set layout (for example, a reduced layout setting or the like), but this will not be described in detail. In S8022, the CPU 305 of the printer 102 calculates, as the insufficient charge number, a value obtained by subtracting the remaining charge amount of the printer information as indicated in Table 1 from the number of sheets required for printing.

In S802, in a case where the calculated insufficient charge number is 0 or less, the charge number is sufficient. Thus, the CPU 305 of the printer 102 executes printing in S803 and responds to the user terminal 103 with the printing result in S804. After printing is executed, the charge number spent via printing is subtracted from the remaining charge amount held as printer information, and the printer information is updated.

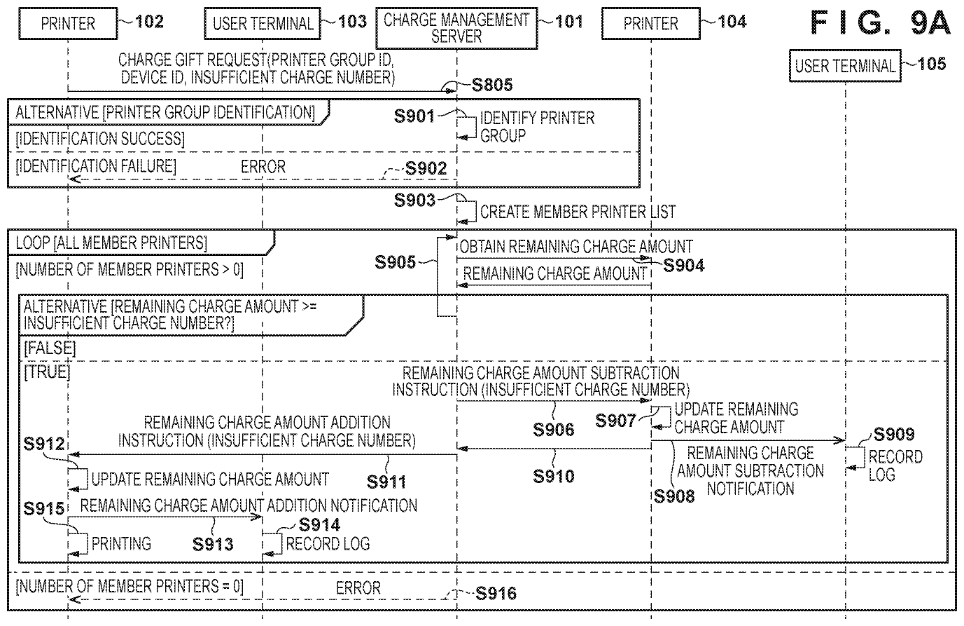

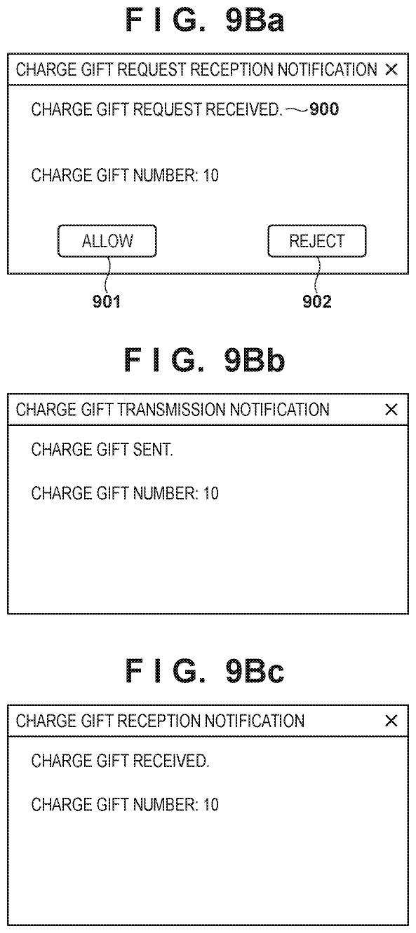

In a case where the insufficient charge number is 1 or greater, the remaining charge amount is insufficient for printing the number of sheets required for printing. Here, in S805, the CPU 305 of the printer 102 transmits the printer group ID, the device ID, and the insufficient charge number included in the printing instruction information to the charge management server 101 as a charge gift request. Thereafter, in S806, charge gift processing is executed. These details will be described with reference to FIGS. 9A and 9Ba to 9Bc.

### Charge Gift Processing

In the following description, the printer that sends a charge gift request is the printer 104. FIG. 9A is a sequence diagram of the charge gift processing executed in S806. The processing of each apparatus appearing in FIG. 9A is implemented by the respective CPUs executing a program.

When the charge management server 101 receives the charge gift request of S805 by the printer 102, in S901, the charge management server 101 identifies the printer group. Specifically, the charge management server 101 checks whether the combination of the printer group ID and the device ID designated in the charge gift request is recorded in the table as indicated in Table 4 and, in a case where the combination cannot be identified, responds to the printer 102 with an error in S902. In a case where the combination can be identified, in S903, the charge management server 101 creates a member printer list. Specifically, from the table indicated in Table 4, using the format indicated in Table 6, the device IDs associated with the printer group ID designated in the charge gift request are listed, excluding the device ID designated in the charge gift request. If the printer 102 belonging to the PrinterGroupX has the device ID of PrinterA and the printer 104 has the device ID of PrinterB, the listed printers include PrinterA and PrinterB as indicated in Table 4. Also, when PrinterA designated in the charge gift request is excluded from these, only the printer 104 is included in the member printer list as indicated in Table 7.

TABLE 6
Example of Member Printer List

| Printer Group ID | Device ID | Remaining Charge Amount |
|---|---|---|
| PrinterGroupX | PrinterA | 50 |
| PrinterGroupX | PrinterB | 100 |

TABLE 7
Example of Member Printer List

| Printer Group ID | Device ID | Remaining Charge Amount |
|---|---|---|
| PrinterGroupX | PrinterB | 100 |

Next, in S904, the charge management server 101 asks the printer 104 for the remaining charge amount. If the remaining charge amount in the response is less than the insufficient charge number obtained in S802 and there is another member printer that has not been a target of S904, in S905, the charge management server 101 executes S904 again on the other member printer. However, in the present example, the member printer list only includes the printer 104 (with the device ID of PrinterB). Thus, in a case where the remaining charge amount of the printer 104 is less than the insufficient charge number, there is no other member printer that has not been a target of S904. In such a case, in S916, the charge management server 101 responds to the printer 102 which is the transmission source of the charge gift request with an error.

If the remaining charge amount in the response to S904 is equal to or greater than the insufficient charge number, that is, equal to or greater than the insufficient number of sheets, in S906, the charge management server 101 transmits a remaining charge amount subtraction processing instruction to the printer 104 together with the insufficient charge number. When the printer 104 receives the remaining charge amount subtraction processing instruction, in S907, the printer 104 executes remaining charge amount update processing. Specifically, the insufficient charge number designated in the remaining charge amount subtraction processing is subtracted from the value for “remaining charge amount” in the printer information indicated in Table 1. Note that in another possible embodiment, before the printer 104 executes remaining charge amount update processing in S907, the printer 104 may display a charge gift request permission screen illustrated in FIG. 9Ba on the user terminal 105 to prompt the user for an operation. On the charge gift request permission screen, a message 900 saying that a charge gift request has been received, the requested charge gift number, an allow button 901 for instructing to grant permission, and a reject button 902 for instructing to reject permission are displayed.

Here, for example, the printer 104 may store the user terminal 105 which is the transmission source of the obtain printer information request at the time of reception and display a charge gift request permission screen on the stored user terminal. Accordingly, for example, a notification for obtaining charge gift request permission may be transmitted from the printer 104 to the user terminal 105 via email or the like, and the URL of the charge gift request permission screen may be embedded or attached to this. In this manner, a charge gift request permission screen provided by a web server of the printer 104 can be displayed on the user terminal 105 via a web browser of the user terminal 105. Also, on the permission screen, if the charge gift request is granted, S907 may be executed. Note that this is merely an example, and the user terminal to display the charge gift request permission screen may be determined via a different method.

In S908, the printer 104 notifies the user terminal 105 of the result of the remaining charge amount subtraction processing, and in S909, the user terminal 105 records a log in the format indicated in Table 8. Also, the user terminal 105 may display a charge gift transmission notification screen illustrated in FIG. 9Bb. At this time, the user terminal 105 may be selected by the same procedure as the user terminal that displays the charge gift request permission screen described above.

TABLE 8
Example of Log Record on User Terminal 105

| | | | Insufficient | |
|---|---|---|---|---|
| Printer | | | Charge | Charge Gift Date |
| Group ID | Device ID | Action | Number | and Time |
| PrinterGroupX | PrinterB | Charge Gift | 10 | 2024 Jul. 24- |
| | | Transmission | | 00:00:00 GMT |

In the log of Table 8, the printer group ID that the printer which is the target of the remaining charge amount subtraction processing belongs to, the device ID of the printer which is the target, the log target action, and the subtracted insufficient charge number, and the charge gift date and time are included. The charge gift date and time may be the date and time of when the log was recorded, for example, or may be the date and time of when the printer 104 updated the remaining charge amount. In the case of the latter, the user terminal 105 receives a remaining charge amount subtraction notification together with the date and time.

In S910, the printer 104 responds to the charge management server 101 with a notification indicating that the remaining charge amount subtraction processing is complete. When the charge management server 101 receives the notification that the remaining charge amount subtraction processing is complete from the printer 104, in S911, the charge management server 101 transmits a remaining charge amount addition instruction to the printer 102 which is the transmission source of the charge gift request. When the printer 102 receives the remaining charge amount addition instruction, in S912, the printer 102 executes remaining charge amount update processing. Specifically, the value designated in the remaining charge amount addition processing, that is, the insufficient charge number is added to the value for “remaining charge amount” in the table of Table 1. In S913, the user terminal 103, which is the transmission source that transmitted the printing instruction to the printer 102, is notified of the result of the remaining charge amount addition processing. When the user terminal 103 receives the remaining charge amount addition processing result, in S914, the user terminal 103 records a log in the format indicted in Table 9. Also, the user terminal 103 may display a charge gift reception notification screen illustrated in FIG. 9Bc. Accordingly, the printer 102 inherits the insufficient amount of the charge number from the printer 104 via the charge management server 101. In other words, the charge management server 101 assigns the insufficient amount of the charge number to the printer 102.

After the remaining charge amount update processing of S913 has ended, the printer 102 executes printing in S915. After printing is executed, the charge number spent via printing is subtracted from the remaining charge amount held as printer information, and the printer information is updated.

TABLE 9
Example of Log Record on User Terminal 103

| | | | Insufficient | |
|---|---|---|---|---|
| Printer | | | Charge | Charge Gift Date |
| Group ID | Device ID | Action | Number | and Time |
| PrinterGroupX | PrinterA | Charge Gift | 10 | 2024 Jul. 24- |
| | | Reception | | 00:00:00 GMT |

In the log of Table 9, the printer group ID that the printer which is the target of the remaining charge amount addition processing belongs to, the device ID of the printer which is the target, the log target action, and the added insufficient charge number, and the charge gift date and time are included. The charge gift date and time may be the date and time of when the log was recorded, for example, or may be the date and time of when the printer 102 updated the remaining charge amount. In the case of the latter, the user terminal 103 receives a remaining charge amount addition notification together with the date and time.

### Effects of Embodiment

According to the present embodiment, in a printer (image forming apparatus) permitted to print a number of sheets in accordance with the remaining charge amount, in a case where the remaining charge amount is insufficient for the number of sheets trying to be printed, the insufficient charge amount can be borrowed from another printer. In the present embodiment, another printer corresponds to a printer that belongs to the same printer group as the printer trying to be used for printing. The borrowed charge is subtracted from the charge of the printer from which the charge is borrowed, and thus the amount of charge possessed as a printer group does not change. Accordingly, a new charge does not occur for the charge added to the printer trying to be used for printing. Also, since charge borrowing is restricted to within the separately set printer group, unexpected loss can be prevented. Furthermore, since a log relating to charge borrowing is recorded, verification after the fact can easily be performed.

### Modification Example

Note that in the present embodiment, the number of sheets that can be printed with the charge number as the unit is unrelated to the page size. However, in a case where the number of sheets that can be printed with the charge number as the unit changes depending on the page size, the number of sheets is counted per page size.

Also, in the present embodiment, the charge number or the remaining charge amount indicates the number of sheets that can be printed, but they may indicate the number of pages. In a case where they indicate the number of pages, the number of sheets required for printing corresponds to the number of pages required for printing for the number of pages to be printed.

Also, the user terminal 105 where the log is recorded in the process illustrated in FIG. 9A corresponds to a user terminal that transmits a join printer group request to add the printer 104 to the PrinterGroupX to the charge management server 101 and stores the obtained printer group information. In a similar manner, the user terminal 103 where the log is recorded corresponds to a user terminal that transmits a join printer group request to add the printer 102 to the PrinterGroupX to the charge management server 101 and stores the printer group information obtained in this manner. Such a combination of a terminal apparatus and printer may be set in advance and stored in each printer. Alternatively, the charge management server 101 that receives the join printer group request may store combinations of transmission source user terminals and target printers. In this case, the charge management server 101 may make a notification to each of the printers of the corresponding user terminal together with the remaining charge amount subtraction instruction or the remaining charge amount addition instruction. In this manner, each printer may learn the user terminal that entered it into the printer group, transmit a remaining charge amount subtraction notification or a remaining charge amount addition notification to the user terminal, and record a log.

Also, in the embodiment described above, the log is recorded in the user terminal. In an alternative configuration, a log may not be recorded in the user terminal and may be centrally recorded by the charge management server 101.

Also, in the embodiment described above, the charge number is borrowed via the charge management server. Alternatively, printer group information may be held by the printers belonging to each printer group, and the charge number may be borrowed directly between printers in the same printer group.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063356, filed Apr. 7, 2025 which is hereby incorporated by reference herein in its entirety.

What is claimed is:

1. A print management system comprising:
a plurality of image forming apparatuses; and
a management server, wherein
each of the plurality of image forming apparatuses holds a printable number of sheets corresponding to a total number of sheets that can be printed, and
a first image forming apparatus among the plurality of image forming apparatuses includes:
at least first memory storing instructions; and
at least first processor that is in communication with the at least first memory and that, when executing the instructions, cooperates with the at least first memory to execute processing, the processing including:
in a case where a first printable number of sheets held by the first image forming apparatus is insufficient with respect to a number of sheets corresponding to a received printing instruction, obtaining, via the management server, a printable number of sheets corresponding to the number of sheets that are insufficient from a second image forming apparatus among the plurality of image forming apparatuses holding a second printable number of sheets equal to or greater than the number of sheets that are insufficient.

2. The print management system according to claim 1, wherein
the processing executed by the at least first processor includes:
in a case where the first printable number of sheets is insufficient with respect to a number of sheets corresponding to a printing instruction, requesting the management server for a printable number of sheets corresponding to the number of sheets that are insufficient, and
the management server includes:
at least second memory storing instructions; and
at least second processor that is in communication with the at least second memory and that, when executing the instructions, cooperates with the at least second memory to execute processing, the processing executed by the at least second processor including:
identifying the second image forming apparatus with the second printable number of sheets equal to or greater than the number of sheets that are insufficient,
issuing an instruction to subtract a printable number of sheets corresponding to the number of sheets that are insufficient from the second printable number of sheets held by the identified second image forming apparatus, and
instructing the first image forming apparatus to add a printable number of sheets corresponding to the number of sheets that are insufficient to the first printable number of sheets.

3. The print management system according to claim 2, wherein
the management server stores information relating to a group of image forming apparatuses, and
the plurality of image forming apparatuses include the first image forming apparatus and an image forming apparatus belonging to a same group as the first image forming apparatus.

4. The print management system according to claim 2, wherein the processing executed by the at least second processor includes:
in response to a request for a printable number of sheets corresponding to the number of sheets that are insufficient, obtaining, from an image forming apparatus among the plurality of image forming apparatuses, the printable number of sheets held by the image forming apparatus, and
identifying the second image forming apparatus for which the second printable number of sheets is equal to or greater than the number of sheets that are insufficient based on the obtained printable number of sheets.

5. The print management system according to claim 1, wherein
the processing executed by the at least first processor includes:
when a printable number of sheets corresponding to the number of sheets that are insufficient is obtained from the second image forming apparatus, adding the obtained printable number of sheets to the first printable number of sheets, and
the second image forming apparatus includes:
at least second memory storing instructions; and
at least second processor that is in communication with the at least second memory and that, when executing the instructions, cooperates with the at least second memory to execute processing, the processing executed by the at least second processor including:
subtracting the printable number of sheets corresponding to the number of sheets that are insufficient obtained by the first image forming apparatus from the second printable number of sheets.

6. The print management system according to claim 5, further comprising at least one terminal apparatus, the at least one terminal apparatus including:
at least third memory storing instructions; and
at least third processor that is in communication with the at least third memory and that, when executing the instructions, cooperates with the at least third memory to execute processing, the processing executed by the at least third processor including:
recording a log of addition of the number of sheets that are insufficient to the first printable number of sheets by the first image forming apparatus and a log of subtraction of the number of sheets that are insufficient from the second printable number of sheets by the second image forming apparatus.

7. An image forming apparatus, comprising:
at least memory storing instructions; and
at least processor that is in communication with the at least memory and that, when executing the instructions, cooperates with the at least memory to execute processing, the processing including:
holding a first printable number of sheets corresponding to a number of sheets that can be printed, and
in a case where the first printable number of sheets is insufficient with respect to a number of sheets corresponding to a received printing instruction, obtaining, via a management server, a printable number of sheets corresponding to the number of sheets that are insufficient from a second image forming apparatus holding a second printable number of sheets equal to or greater than the number of sheets that are insufficient.

8. The image forming apparatus according to claim 7, wherein the processing includes:
responding with the first printable number of sheets in response to a request for the printable number of sheets from the management server.

9. The image forming apparatus according to claim 7, wherein the processing includes:
in response to each of an addition instruction and a subtraction instruction for a printable number of sheets with respect to the first printable number of sheets from the management server, performing each of addition and subtraction of an instructed printable number of sheets with respect to the first printable number of sheets.

10. The image forming apparatus according to claim 7, wherein the processing includes:
when printing is executed in response to the printing instruction, subtracting the number of sheets from the first printable number of sheets.

11. A management server connected to a plurality of image forming apparatuses, the management server comprising:
at least memory storing instructions; and
at least processor that is in communication with the at least memory and that, when executing the instructions, cooperates with the at least memory to execute processing, the processing including:
upon receiving, from a first image forming apparatus among the plurality of image forming apparatuses, a request for a number of sheets that are insufficient corresponding to insufficiency of a first printable number of sheets held by the first image forming apparatus with respect to a number of sheets corresponding to a printing instruction received by the first image forming apparatus, identifying a second image forming apparatus for which a second printable number of sheets held by the second image forming apparatus is equal to or greater than the number of sheets that are insufficient, based on a printable number of sheets held by each of the plurality of image forming apparatuses, and
obtaining a printable number of sheets corresponding to the number of sheets that are insufficient from the second image forming apparatus and assigning the obtained printable number of sheets to the first image forming apparatus.

12. The management server according to claim 11, wherein the processing includes:
storing information relating to a group of image forming apparatuses, and
the plurality of image forming apparatuses include the first image forming apparatus and an image forming apparatus belonging to a same group as the first image forming apparatus.

13. A non-transitory computer-readable storage medium storing a program that causes a computer to execute processing when loaded and executed on the computer, the processing including:
holding a first printable number of sheets corresponding to a total number of sheets that can be printed, and
in a case where the first printable number of sheets is insufficient with respect to a number of sheets corresponding to a received printing instruction, obtaining, via a management server, a printable number of sheets corresponding to the number of sheets that are insufficient from a second image forming apparatus holding a second printable number of sheets equal to or greater than the number of sheets that are insufficient.

14. A non-transitory computer-readable storage medium storing a program that causes a computer to execute processing when loaded and executed on the computer, the processing including:
upon receiving, from a first image forming apparatus among the plurality of image forming apparatuses, a request for a number of sheets that are insufficient corresponding to insufficiency of a first printable number of sheets held by the first image forming apparatus with respect to a number of sheets corresponding to a printing instruction received by the first image forming apparatus, identifying a second image forming apparatus for which a second printable number of sheets held by the second image forming apparatus is equal to or greater than the number of sheets that are insufficient, based on a printable number of sheets held by each of the plurality of image forming apparatuses, and
obtaining a printable number of sheets corresponding to the number of sheets that are insufficient from the second image forming apparatus and assigning the obtained printable number of sheets to the first image forming apparatus.

15. A print management method for a print management system including a plurality of image forming apparatuses and a management server, comprising:
each of the plurality of image forming apparatuses holding a printable number of sheets corresponding to a total number of sheets that can be printed; and
a first image forming apparatus among the plurality of image forming apparatuses, in a case where a first printable number of sheets held by the first image forming apparatus is insufficient with respect to a number of sheets corresponding to a received printing instruction, obtaining, via the management server, a printable number of sheets corresponding to the number of sheets that are insufficient from a second image forming apparatus, among the plurality of image forming apparatuses, holding a second printable number of sheets equal to or greater than the number of sheets that are insufficient.
